(19) United States
(12) Patent Application Publication
(10) Pub. No.: US 2014/0278815 A1
(43) Pub. Date: Sep. 18, 2014

(54) SYSTEMS AND METHODS FOR MARKET ANALYSIS AND AUTOMATED BUSINESS DECISIONING

(71) Applicant: Strathspey Crown LLC, Newport Beach, CA (US)

(72) Inventors: Robert Grant, Laguna Beach, CA (US); David Mordaunt, Los Gatos, CA (US); Jennifer Mons, San Clemente, CA (US)

(21) Appl. No.: 14/189,416

(22) Filed: Feb. 25, 2014

Related U.S. Application Data
(60) Provisional application No. 61/778,183, filed on Mar. 12, 2013.
(60) Provisional application No. 61/782,975, filed on Mar. 14, 2013.
(60) Provisional application No. 61/785,176, filed on Mar. 14, 2013.

(51) Int. Cl. G06Q 10/06

(52) U.S. Cl. CPC G06Q 10/0637
USPC 705/7.36

(57) ABSTRACT

One embodiment includes an environment for analyzing various data associated with companies, market participants, customers, products, services and/or related data, processing the data to identify factors correlating with market success, and for utilizing such data to suggest or optimize business decisions, measure return on investment, forecast sales or revenue, and/or to automate decisions regarding a company's operations, product development, marketing and/or allocation of resources.

### CROSS-REFERENCE TO RELATED APPLICATIONS

This application claims benefit of priority to U.S. Patent Application No. 61/778,183, filed on Mar. 12, 2013, entitled “SYSTEMS AND METHODS FOR MARKET PARTICIPANT-BASED AUTOMATED DECISIONING” and claims benefit of priority to U.S. Patent Application No. 61/782,975, filed on Mar. 14, 2013, entitled “SYSTEMS AND METHODS FOR MARKET ANALYSIS AND AUTOMATED BUSINESS DECISIONING” and claims benefit of priority to U.S. Patent Application No. 61/785,176, filed on Mar. 14, 2013, entitled “SYSTEMS AND METHODS FOR MARKET ANALYSIS AND AUTOMATED BUSINESS DECISIONING”, each of which is hereby incorporated herein by reference in its entirety.

### GENERAL BACKGROUND OF CERTAIN EMBODIMENTS

In the healthcare industry, some existing systems may store data regarding shipments of a product to doctors' offices, but may not receive data regarding when specific products were used by the doctor in a procedure or purchased by a patient or other consumer.

### FIELD OF THE INVENTION

The disclosure generally relates to an environment for analyzing various data associated with companies, market participants, customers, products, services and/or related data, processing the data to identify factors correlating with market success, and for utilizing such data to suggest or optimize business decisions, measure return on investment, forecast sales or revenue, and/or to automate decisions regarding a company's operations, product development, marketing and/or allocation of resources.

### SUMMARY OF CERTAIN EMBODIMENTS

One embodiment discloses a system for automatically generating an electronic action recommendation based at least in part on various data, the system comprising: a data store that stores information associated with a plurality of companies; and a computing device in communication with the data store and that is configured to: receive data associated with one or more of the companies from a plurality of data sources, wherein the received data comprises data related to at least one of sales, inventory, marketing, operations or product design; automatically analyze the received data and data retrieved from the data store to determine one or more aspects of at least one company that correlate with one or more criteria to be optimized; and automatically generate an electronic action recommendation to be taken by at least one company based at least in part on the one or more determined aspects.

One embodiment discloses a computer-implemented method for automatically generating an electronic action recommendation based at least in part on various data, the computer implemented method comprising, as implemented by one or more computing devices configured with specific executable instructions: electronically receiving data associated with a plurality of companies from a plurality of data sources, wherein the received data comprises data related to at least one of sales, inventory, marketing, operations or product design; automatically analyzing the received data to determine one or more aspects of at least one company that correlate with one or more criteria to be optimized; and automatically generating an electronic action recommendation to be taken by at least one company based at least in part on the one or more determined aspects.

### BRIEF DESCRIPTION OF THE DRAWINGS

Specific embodiments will be described with reference to the following drawings

FIG. 1 is one embodiment of an illustrative operating environment that includes an analysis system in communication with a participant community platform, a credit and financing system, a business management system, an inventory tracking system, a customer community platform, and third party data sources, and in which corporate user systems, participant systems and customer devices are in communication with one or more of the other illustrated systems.

FIG. 2 is one embodiment of illustrative data flow among the various systems, devices and data sources illustrated in FIG. 1.

FIG. 3 is one embodiment of a flow diagram of an illustrative method for automatically determining one or more factors that correlate with success in one or more desired business areas based at least in part on received data of various types, and for automatically generating a recommended business decision or action based at least in part on these factors.

FIG. 4 illustrates one embodiment of a configuration of an analysis system for implementing aspects of the disclosure.

### DETAILED DESCRIPTION OF THE EMBODIMENTS

Aspects of the present disclosure relate to an analysis system that may leverage data from various other systems, data sources and/or platforms to conduct market research, measure and analyze the return on investment of various marketing or other business decisions, identify “x-factors” that lead to success in a given area of business and/or to at least partially automate various business decisions of a company. According to some embodiments, the analysis system may analyze inventory data, sales data, marketing data, crowdsourced participant and/or consumer data, and/or various other data described herein to provide a data engine whose information is utilized to make better business decisions.

According to some embodiments, aspects of the present disclosure may utilize disparate data from a number of other systems and/or data sources in order to enable an informed enterprise, whereby a market participant or company may optimize various aspects of its marketing, product development, operations and/or other business decisions based on accurate analysis, forecasting and/or return on investment (“ROI”) measurements provided by the analysis system. In some embodiments, an analysis system, as described herein, may utilize real time inventory data or other market data to correlate products with specific end-users or consumers in order to effectively measure usage lifts in a market and pinpoint their sources.

In some embodiments, the analysis system, as disclosed herein, may provide predictive outcome information based on inventory data, product feedback, sales data, marketing information, and/or various other data described herein. As one example, the analysis system may leverage various received data associated with a number of companies in order to provide predictive information to a company regarding the likely market share effects and/or revenue changes if the company changes messaging in a particular medium or in a particular market. The analysis system may leverage data regarding end-user or end-customer sales or usage to correlate usage lifts of a product or service (which may include the percentage of usage lift and/or duration of usage lift) with various business decisions made prior to the lift. The analysis system may provide, for example, a forward-looking prediction and/or recommendation to a market participant or company based on aggregated data analysis of the market effects of previous business decisions of one or more companies.

In some embodiments, the analysis system may receive data reflective of actual usage or end-user purchase, in contrast to systems that may only receive data regarding sales by a manufacturer or distributor to a retailer, reseller, doctor, and/or other business in a business-to-business-to-consumer (“B2B2C”) distribution model. For example, in the healthcare industry, some existing systems may store data regarding shipments of a product to doctors' offices, but may not receive data regarding when specific products were used by the doctor in a procedure or purchased by a patient or other consumer. In some embodiments, an inventory tracking system, discussed below, may provide the analysis system with real time or near-real time data regarding the actual movement or use of inventory within a doctor's office, hospital, retailer and/or other business. In addition, a customer community platform, also discussed below, may provide the analysis system with feedback from the consumer as to their overall experience with the provider and the procedure, as well as a review of the product. By tracking end-user sales or actual use of the product, the inventory tracking system may provide inventory data that enables the analysis system to accurately measure correlations between various business decisions, subsequent changes in product usage or end-user sales, and consumer satisfaction. The analysis system may then use information regarding market effects of a decision by one company and/or in one region in order to forecast likely effects in another region and/or with respect to another company.

According to some embodiments, the analysis system may analyze various data associated with buyers or market participants in order to identify movements in a particular participant's buying patterns or volume. For example, the analysis system may analyze inventory data for a number of physicians and determine that one or more physicians have recently increased usage or sales of a particular product. The analysis system may then analyze various input data received from a variety of systems and/or data sources to determine one or more “x-factors” of the identified physicians that appear to correlate with the increased usage and/or appear to be at least partially responsible for the given physician's performance. Based at least in part on aggregated data related to a number of companies, products and/or services, the analysis system may then provide suggested actions to a given target company, participant, product and/or service regarding how business changes or actions regarding one or more determined x-factors may enable the target to improve market performance.

In some embodiments, one or more reports or user interfaces generated by the analysis system may identify portions or aspects of a target company's practice, products, procedures or business processes that could be altered in order to optimize product effectiveness, sales, market share and/or profitability. Accordingly, aspects of the present disclosure may provide data, scores and/or reports used to drive decisions regarding a company's operations, product development, marketing and/or allocation of resources. In other embodiments, one or more generated scores and/or reports may indicate a target company's viability as a profitable investment, and may be used in whole or in part to make an acquisition or investment decision. In some embodiments, the goals of a company are ranked, prioritized, and then compared with the company's actual performance, such that the analysis system may then provide recommendations or generate automated actions to help align the company's performance with its goals. For example, the company may be underperforming in one area that is ranked as a high priority. The analysis system can generate information on what specific tasks and/or activities are most likely to provide a timely lift in that particular area. In addition, the company may be over-performing in another area that is ranked as a low priority. The analysis system can generate information on what specific tasks and/or activities to initiate or halt in order to stop the over-performance of that particular area without affecting the company's performing in higher-ranked areas.

While the example of healthcare products and procedures are often used herein as examples of a target's products or services, in other embodiments, an analysis system as disclosed herein may be configured to analyze data for targets related to any industry. Aspects of the present disclosure, according to some embodiments, may be particularly suited to any industry where product sales are driven by the provider instead of by the consumer. In some embodiments, feedback may be received from industry professionals, providers or other participants from within a given target's industry, rather than from patients, physicians or other medical professionals.

The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the systems and methods described herein.

### Example Computing Environment and Data Flow

FIG. 1 is one embodiment of an illustrative operating environment that includes an analysis system 100 in communication with a participant community platform 104, a credit and financing system 106, a business management system 112, an inventory tracking system 114, a customer community platform 116, and third party data sources 174, and in which corporate user systems 176, participant systems 170 and customer devices 172 are in communication with one or more of the other illustrated systems. As discussed in more detail below, the illustrated systems may communicate by way of wired and/or wireless communication links via a network 160, which may be one or more of a LAN, WAN, and/or the Internet, for example.

In other embodiments than that illustrated in FIG. 1, one or more of the systems in communication with the analysis system 100 may be omitted and/or one or more of the systems may be combined into a single system and/or run by a third-party system. In addition, systems for implementing the functionality described herein may include additional or fewer components than are illustrated in the example of FIG. 1. In some embodiments, one or more of the systems and/or devices illustrated in FIG. 1 may include a personal computer, a laptop computer, a server, a cell phone, a personal digital assistant, a media player, a touch screen device, a gaming system, a tablet, and/or any other computing device. An example configuration of the analysis system 100 and/or other systems illustrated in FIG. 1 is discussed in more detail below with reference to FIG. 4. The functionality of the various illustrated systems and example communications between the various illustrated systems via the network 160 will now be described with reference to FIG. 2.

FIG. 2 is one embodiment of illustrative data flow among the various systems, devices and data sources illustrated in FIG. 1. In the illustrated embodiment, the analysis system 100 receives data from the participant community platform 104, the credit and financing system 106, the business management system 112, the inventory tracking system 114, the customer community platform 116, and third party data sources 174. The analysis system 100 may analyze the various received data and send resulting decisions, scores, reports and/or other information to one or more of the illustrated systems. The provided information may be used, in some embodiments, to make business decisions regarding operations, marketing, product design, capital investment, and/or inventory management of a company; determine x-factors or aspects of a participant, practice, company, product or service that are likely to increase market share for a participant, practice, company, product and/or service based on analysis of historical data; provide a recommended business decision for a target company or participant based on comparison of identified x-factors with corresponding data of the target; optimize a participant's practice or business; optimize a target product or service; optimize a target company; analyze a company, product and/or service for acquisition or investment; conduct market research; and/or identify market trends. Example methods for analyzing the received data are described in more detail below with reference to FIG. 3.

As illustrated in FIG. 2, a number of participant systems 170 may communicate with the participant community platform 104. The participant systems 170 may be computing devices used by market participants, such as physicians in some embodiments within the healthcare field. The participant community platform 104 may enable a number of participants with shared interests or business areas (such as specialty physicians) to interact with each other and/or various other parties via a social network service, messaging, surveys, polls, and/or various other communication methods. The participant community platform 104 may be considered, in some embodiments, a forum where physicians (or industry participants in any targeted industry, in some embodiments) may engage with one another and/or with investment or corporate entities in a manner that may directly impact the direction of a company, a product or a service, or may improve the participant's own practice or business.

Participant Community Platform

In the illustrated embodiment, the participant community platform 104 may provide a social network service and/or may enable participants (such as physicians or other participants utilizing participant systems 170) to engage in activities such as providing product or service feedback, voting, completing surveys, completing online training or education, authoring blogs or other content, providing or tracking information regarding their practice or business, connecting with and sharing content within a selective group of like-minded participants, and/or other features. In some embodiments, participants may be members of smaller networks or groups based on one or more of a specialty, experience level, a category expertise, and so forth. In some embodiments, the platform may encourage content engagement through rating and commenting of content, and may also enable searching, categorizing or tagging content. The platform may also encourage the participants to rate or “like” other participants of the system. A participant may be encouraged to actively participate in various aspects of the platform in order to increase a participant's influence score, which may be determined by the analysis system in some embodiments.

According to some embodiments, the participant community platform 104 may collect and analyze industry participants' opinions to refine a company's strategy and/or to focus on delivering services and offerings that matter most to customers. In some embodiments, the customer community platform 116 may gather product or service feedback from various consumers (such as patients, in the example of health-related products or procedures). In some embodiments, feedback data such as social media “likes,” participant comments, and/or survey data collected via the participant community platform 104 and/or customer community platform 116 may be used to gather customer or participant opinions on a given company's products (or a portfolio of companies' products) compared to the competition, as well as relative to customer needs. In some embodiments, subsequent analysis of such data by the analysis system 100 may be used to compare a given company, participant, product and/or service across many platforms and data types to determine what makes a given company, participant, product or service different than others within a given market or region, and/or within a given industry. Such differentiating factors may then be used to provide recommendations to one or more target participants, products, services and/or companies regarding business decisions or other actions to be taken, as further discussed below.

In some embodiments, feedback of each consumer (as received from the customer community platform) or participant (as received from the participant community platform) may be weighted according to an influence score generated for the participant or customer by the analysis system. Accordingly, aspects of the present disclosure may enable a company to utilize crowd intelligence or “crowd IQ” in order to make business decisions that improve a company's market share in a given industry. In some embodiments, an analysis system described herein may mine data related to a number of industry participants to inform the company's decisions related to operations, marketing, product design, capital investments and other investments, advertising, inventory management, and/or other business decisions. The analysis system may be further configured, in some embodiments, to analyze data that provides an objective indication of whether one or more investment or business decisions have resulted in an increased market share. For example, aspects of the present disclosure may provide a real time or near-real time indication of the return on investment (“ROI”) of marketing, product design, operational and/or other decisions based on actual market data. Accordingly, aspects of the present disclosure may enable a company to align its resources and efforts with customers' desires. In some embodiments, the received feedback and/or other data may be modified to remove personally-identifiable information and then sold or otherwise provided to a third-party.

Inventory Tracking System

As further illustrated in FIG. 2, the analysis system 100 may receive inventory data from the inventory tracking system 114. The inventory tracking system 114, in some embodiments, may provide the analysis system with real time or near-real time data regarding the actual movement or use of inventory within a doctor's office, hospital, retailer and/or other business. For example, the inventory tracking system may receive information from various doctors' offices or other businesses (depending on the industry) regarding the movement or use of specific products, which may be received automatically in real time or near real-time, and/or received in batches or other periodic updates.

The inventory data may include, for example, an indication of the products that are currently in inventory at a given physician's office or other business. In some embodiments, the offices or other businesses may track inventory based at least in part on automated systems employing radio-frequency identification (“RFID”) tags, bar codes, QR codes, and/or other automated identification markings on the inventory. Automated inventory tracking may be beneficial, for example, if an entity stores a large amount of inventory at a given time, and/or has expensive products in inventory. An inventory tracking system may help to identify when products are stolen and/or when products expire. The inventory tracking system 114 may be configured to automatically send an order for a replacement product in response to a product being sold, expiring or being stolen. In some embodiments, the inventory tracking system 114 may link products sold and specific patients or other customers that purchased or used the products. In some embodiments, the inventory tracking system 114 may associate a product with a specific patient (or other end-user) and date.

The analysis system may use information regarding specific customers, in some embodiments, to track the success of marketing campaigns or other customer acquisition methods of a given company by calculating a concrete estimate of ROI of specific campaigns. By tracking end-user sales or actual use of the product, the inventory tracking system may provide inventory data that enables the analysis system to accurately measure correlations between various business decisions, subsequent changes in product usage or end-user sales, and consumer satisfaction. In some embodiments, the inventory tracking system 114 may track shipments, lead time, shipment progress, costs and other factors related to distribution of products in a manner that enables the analysis system to determine the optimal order sizes, order timing, and/or the proper distributor or other product source for a given company or practice. Accordingly, a company may utilize data or recommendations from the analysis system to adjust inventory and place orders in a cost effective and efficient manner.

In some embodiments, the analysis system 100 may use the inventory data received from the inventory tracking system 114 at least in part to determine not only lift in sales, but also in usage for a given product in a given time period. As will be discussed in more detail below, data from other systems, such as from the customer community platform, business management system 112 and/or a marketing data source may be used by the analysis system to correlate the recognized sales and/or usage lift to one or more marketing campaigns or other x-factors in order to determine an accurate ROI calculation for marketing money spent by a company.

Credit and Financing System

In some embodiments, the credit and financing system 106 may be operated by a financing company, credit company or corporate division that provides loans or financing for products, procedures or services in the relevant industry of a given embodiment. For example, in the case of an analysis system configured to operate in the private-pay sector of the healthcare industry, the credit and financing system may be responsible for receiving applications from potential patients desiring a given product or procedure, may analyze the applications for credit worthiness or other information, and may determine whether to finance the patient's product or procedure. In some embodiments, the credit and financing system 106 may receive a variety of financial information, personal information, credit information and/or various demographic data associated with applicants for credit or financing. In some embodiments, the credit and financing system 106 may provide some or all of this data to the analysis system 100 to be considered by the analysis system when analyzing the demand for a product or service, the success of certain marketing or business decisions, trends in the market, correlations between different procedures and/or products, and/or a variety of other determinations. In some embodiments, the data provided to the analysis system 100 may be filtered or adjusted in order to not provide certain sensitive information or information identifying specific individuals.

In some embodiments, the credit and financing system 106 may provide the analysis system 100 with information regarding specific customers that are purchasing specific products or services, and/or information regarding specific patients that are receiving specific medical procedures. Accordingly, the credit and financing system 106 may provide the analysis system 100 with information regarding demographics of consumers, patients or customers purchasing products, services or procedures by income, age, gender, location, service provider or seller, or other personal or demographic information. The analysis system 100 may analyze such data, alone or in combination with data received from the various other system of FIG. 2, in order to identify trends and correlations in the data. For example, the analysis system may determine that a particular medical procedure being purchased by a given individual often leads to the same individual requesting a certain other procedure within a three to six month window after the first procedure is performed. The analysis system may, in some embodiments, use the resulting analysis of the received financing and demographic data in order to recommend demographics for a given company to target in marketing efforts. In some embodiments, the credit and financing system 106 may open up new avenues of clients for a participant, such as new patients for a physician, because the credit and financing system 106 may provide credit to patients with lower cost to the physician than in other financing arrangements that involve third-party financiers.

Consumer Community Platform

The consumer community platform 116, in some embodiments, may provide data to the analysis system 100 regarding a number of individuals operating customer devices 172. The individuals may be users of a service provided by the customer community platform for interacting with other users. For example, the consumer community platform 116 may provide an interactive community via the network 160 whereby users can find other individuals that are similar to them, discuss products, procedures or services among each other and/or in public forums, provide structured or unstructured feedback regarding products, services, providers and/or participants, and/or participate in various other interactions. The consumers may publish information about certain products, services, and/or procedures the consumers have used (for example, links to the product, service, and/or procedure, links to the provider, and/or photos showing “before” and “after” perspectives) and/or “share” this information by publishing the information on the consumer's social media page, publishing the information on a community page, publishing the information on a public page, and/or sending the information to the consumer's circle of contacts via a link, message, text message, wall posting, and so forth.

The consumer community platform 116 may, in some embodiments, provide surveys to patients or consumers regarding products or services, and/or may provide a refer-a-friend program for a product or service. The consumer community platform 116 may also include non-social aspects, such as, for example, a survey that a consumer may complete and submit without disclosing the consumer's identity to the rest of the community or completely withholding the consumer's identity.

In some embodiments, at least some of the individuals using consumer community platform 116 may be people that have visited a webpage, application, or user interface associated with the consumer community platform 116 in response to an advertisement or other promotional effort of a company. For example, the consumer community platform 116 may be configured to track marketing campaigns of one or more companies. The consumer community platform 116 may track a variety of local advertising campaigns, social media or viral marketing campaigns, and/or national advertising campaigns. For example, a number of companies may run advertising campaigns that include a call to action in the promotional message (whether by radio, television, any other broadcast medium, Internet, print, or other medium) that instructs interested consumers to interact with the consumer community platform 116 or an operator of the consumer community platform, such as by instructing the consumer to visit a website, request a page or user interface, call a phone number, send email to a specific email address and/or other action. In some embodiments, the call to action may be received indirectly by the consumer community platform 116 and/or analysis system 100. As an example, an interested consumer may be directed in a marketing message to call a given doctor's office and mention a certain promotional code, which the doctor's office may then send or otherwise provide to the consumer community platform 116 or analysis system 100.

In some embodiments, the analysis system 100 may receive data from the consumer community platform 116 regarding initial referrals of patients or other consumers, along with the source of the referral. For example, the consumer community platform 116 may provide the analysis system 100 with information regarding the number of individuals and the demographics of individuals that responded to the call to action of a given marketing campaign. The individuals may provide the information voluntarily or may provide the information based on incentives offered by the consumer community platform 116. The analysis system 100 may then correlate this information with data provided by the inventory tracking system 114 and/or the credit and financing system 106 in order to determine how many of those individuals actually purchased the product in question, received the procedure in question, or otherwise converted to a sale or use subsequent to showing interest in the product or procedure. The analysis system may then use the information regarding the closing rate (such as the ratio of the number of products sold or used to the number of campaign referrals) within a given time period, demographic, region, industry, company or other area in order to determine optimal marketing strategies going forward in any of these areas, and/or to generate a corresponding recommendation to one or more companies, participants or service providers. In this and other manners, the analysis system 100 may recognize switches or upticks in sales or use of a product or service within a given region, demographic or other area. The analysis system 100 may additionally or alternatively correlate consumer excitement with respect to a given product or service with actual sales or use of the given product or service.

Third-Party Data Sources

In some embodiments, the third-party data sources 174 may provide the analysis system 100 with various data regarding companies, participants, markets, products, services, and/or other information. As some examples, according to some embodiments, data from third-party data sources 174 may include data related to public records, a social networking service, business records, scholarly or academic publications, industry information, market and financial data, corporate earnings data, presentation data, professional journals or publications, patents and related publications, and/or other types of data regarding companies, doctors, businesses, medical groups, individuals, etc. The social network data may include, for example, information regarding the mention of specific products, companies, services, participants (such as doctors), and/or other relevant data in blogs, posts, status updates and/or other content posted to third-party social media services by customers, participants and/or the general public.

Business Management System

A business management system 112 may be used to track a business's current operations, to provide benchmarking data showing how the business compares with other peer businesses, to provide recommendations for actions that can better align the business with its goals, and/or to generate electronic actions that adjust or modify the business's operations and/or budget. The various determinations and/or recommendations made by the analysis system 100 may be provided to companies or other users of corporate user system 176 via the business management system 112. As one example, the analysis system 100 may determine that a company should run a targeted marketing campaign focused on 40-50 year old males in the Midwest during the summer, with the campaign running for two weeks on certain radio stations identified to provide a lift relative to this demographic and region. The analysis system may send such business optimization information or recommendations to the business management system 112 in order for the business management system 112 to generate a user interface that includes the suggested recommendation for display to a decision maker within a company or practice. The user interface may further include, for example, an indication of the expected lift amount and duration of lift in sales or usage expected within a given time frame as a result of taking the recommended action.

The business management system 112 may provide a variety of services to corporate users, such as management or other decision makers at a company or practice. For example, the business management system 112 may provide services related to office systems, education and/or marketing. Office system services may include software related to billing, marketing, patient tracking (or other consumer tracking), and/or inventory management. Office system services may additionally or alternatively include reports regarding campaign tracking, practice performance metrics, and/or custom alerts. Office system services may additionally or alternatively include benchmarking services, whereby office management data may be stored in a cloud computing environment or similar service and utilized for benchmarking or comparing similar practices or companies.

The education services provided by the business management system may include online curriculum, society certification and/or consultant training. For example, the online curriculum may provide courses related to phone skills for coordinators, consultative selling for front desk employees, managing the patient lessons for nurses, practice management lessons for managers, and/or marketing-related skills for marketing department members. In some embodiments, the education modules or courses offered to a given company or corporate user may be determined dynamically by the analysis system 100 based on an analysis of areas in which the company or practice is underperforming and/or analysis of usage or sales lifts of competitor companies or practices attributed to certain education efforts or course completion by competitors in the past. Consultant training services provided by the business management system may include practice evaluation and planning, financial analysis and staff management, marketing and practice development, staff and leadership training, cheat sheet development, and/or application of learning from one or more reports generated by the analysis system.

Marketing services provided by the business management system 112 may include resources related to co-op marketing, services for finding a doctor or service provider, and/or patient or consumer feedback. For example, the co-op marketing may provide resources and recommendations regarding print ads, radio ads, television ads, posters, customer relationship management (“CRM”) and/or other resources or services. In some embodiments, the marketing information may by tailored for the given company or user based on analysis by the analysis system 100 regarding inventory data, marketing data and/or other data received from the customer community platform, inventory tracking system and/or other systems or data sources, such as that described above. The services related to finding a doctor, participant or other service provider may include, for example, search features, scheduling features, appointment reminders or other information. In some embodiments, information regarding specific doctors, participants or other service providers may include a score indicating a relative quality and/or influence of the given individual, as calculated by the analysis system 100. The marketing services may additionally or alternatively include patient feedback services that receive patient or consumer feedback regarding physician or participant ratings, patient or consumer testimonials, patient referrals, and/or relevant information determined from one or more social media services.

In some embodiments, the analysis system 100 and/or the business management system 112 may generate user interfaces for viewing by users of corporate user system 176 which provide a dashboard whereby a user can monitor a product experience trial, track consumer and participant sentiment and/or optimize market penetration. In some embodiments, the user of the corporate user system 176 may view deep, real time data and/or may view visualizations of consumer behavior and emerging trends. The business management system may support segmentation and may influence program enhancements relative to a target company, product or service. The business management system may further provide recommendations regarding marketing campaigns, as discussed above, and/or for product or packaging refinements based upon consumer and/or participant feedback. In some embodiments, key opinion leaders may be recognized by the analysis system 100 and their actions and opinions utilized to accelerate market penetration for a given product.

In some embodiments, one or more user interfaces generated by the analysis system 100 and/or the business management system 112 may include an indication of suggested actions to be taken by a company, a practice or one or more individuals. As one example, a dashboard user interface may indicate that the patient flow at a given doctor's practice is down and appears to be an education issue. The user interface may suggest that two education modules be consumed by the front desk employees, and may include a selectable option to view the identified educational modules. Such a determination may be made by the analysis system 100 based at least in part on a determination that one or more successful practices in a similar region saw historical improvements in patient flow within two months of receiving the identified education. One or more user interfaces may track the progress of completing suggested actions, such as indicating that a given practice has completed 80% of its recommended education modules.

In some embodiments, “x-factors” or drivers of performance identified by the analysis system may be a combination of factors, such as increased marketing and increased education. For example, a user interface may inform a decision maker in a given company or practice that there are five actions that the company or practice could take to see improvements in a given metric that they wish to focus on or maximize, where the metric to be maximized may be determined by the analysis system or by the corporate user, depending on the embodiment. As examples, the metric to be maximized (or minimized, as appropriate) may be one of, or a combination of, sales, usage, customer satisfaction, cost, allocation of resources, revenue, profits, closing rates or efficiency, gross margins, and/or other criteria.

Example Method

FIG. 3 is one embodiment of a flow diagram of an illustrative method implemented by the analysis system 100 for automatically determining one or more factors that correlate with success in one or more desired business areas based at least in part on received data of various types, and for automatically generating a recommended business decision or action based at least in part on these factors. The method may be stored as a process accessible by the analysis system 100 and/or other components of the analysis system 100. Depending on the embodiment, certain of the blocks described below may be removed, others may be added, and the sequence of the blocks may be altered.

The illustrative method begins at block 302, where the analysis system 100 receives and/or accesses various data associated with a number of companies, products and/or services, where the data may relate to sales, inventory, marketing, operations, product design, customer or participant feedback, and/or other areas. In some embodiments, the received data may be any of the data described above as examples of data provided by the participant community platform 104, the credit and financing system 106, the business management system 112, the customer community platform 116, the inventory tracking system 114 and/or third-party data sources 174.

At block 304, the analysis system 100 may analyze data regarding sales, usage, customer satisfaction, cost, allocation of resources, revenue, profits, closing rates or efficiency, gross margins, customer opinions and/or other metrics or criteria to be maximized (or minimized, as desired) in order to identify one or more top companies, products or services with respect to desired metrics or criteria. In some embodiments, the metrics or criteria desired to be optimized may be determined by the analysis system, such as by determining aspects of a business that generally successful enterprises have prioritized in a given industry. In other embodiments, the criteria or metrics to be optimized may be selected by a user, such as a corporate decision maker interacting with business management system 112, based on a given company's desired focus or priorities. In some embodiments, the top companies, products and/or services with respect to the desired criteria may be determined by comparing the relevant received data for a number of different companies to identify positive outliers or standout companies with respect to the given criteria. In some embodiments, block 304 may be optional or not implemented, such that the analysis system determines x-factors that appear to correlate with success relative to the given criteria or metrics without explicitly identifying standout companies, products and/or services with respect to the desired criteria or metrics.

At block 306, the analysis system 100 analyzes the received data to determine one or more x-factors that correlate with the desired criteria or metrics to be optimized. Depending on the embodiment, the analysis system 100 may consider only data associated with the top companies, products or services identified at block 304, or may consider data regarding any company, product or service that is similar to a target company, product or service for which the method is being implemented in a given instance. The analysis system 100 may determine the correlation data, in some embodiments, by implementing one or computation methods or models that are capable of receiving input datasets and outputting information regarding perceived correlations or patterns between certain fields or types of the input data and other fields or types of the input data. As one example, an artificial neural network may be implemented by the analysis system 100 in order to identify correlations between one or more factors or data types within the various received data and the one or more criteria to be optimized. As one example, according to an embodiment in which patient referrals are the metric to be maximized, the analysis system 100 may determine that relatively high marketing spend on print advertising in trade magazines and publishing articles in academic journals each have strong correlation with increased patient referrals for a doctor or practice within a given specialty in a 6 month time frame. The analysis may also utilize segmentation tools to further divide the dataset into subsets which can be analyzed separately using a variety of segments. For example, the analysis may be performed on consumers within a particular income range, age, zip code, with a particular medical history, gender, occupation, and so forth; practitioners within a certain region, within a certain practice area, with a certain clientele, with certain credentials, with a particular amount of experience, and so forth; and/or marketing campaigns conducted within a certain time period, via a specific medium, using a particular company, focused on a certain demographic, and so forth.

Next, at block 308, the analysis system 100 may compare corresponding data associated with at least one company, product or service with the x-factor data determined at block 306. The company may be, for example, a company for which one of the executives or other members has requested a report, recommendation or other information from the analysis system. In other embodiments, a company, product or service may be a company, product or service that is a potential investment or acquisition target. Using the above example in which the analysis system determines that an x-factor for success in a given area is a relatively high marketing spend on print advertising in trade magazines, the analysis system 100 may analyze the company's marketing spend on print advertising in trade magazines relative to the amount of marketing that has proven successful for the identified top companies. The analysis system may then determine whether the company is over-performing, underperforming or optimally positioned with respect to one or more x-factors. In some embodiments, a variety of data previously discussed above may be used to determine marketing information, education information, sales and usage information, and/or other information regarding a company.

At block 310, the analysis system 100 may present a recommended business decision for the target company, product or service and/or generate an action based at least in part on the x-factor analysis described above. Some example dashboards or user interfaces providing such data are discussed above with reference to FIG. 2. In some embodiments, a recommended business decision may include, for example, decisions related to operations, marketing, product design, capital investments and other investments, advertising, inventory management, education, customer relations, and/or other business decisions. For example, some example decisions may include required online training sessions, setting of future budgets, deciding what inventory to purchase, deciding when to purchase certain products, deciding which distributor to use, deciding which regions or practices to disburse products to, choosing what ads to use, where to use them, and when to air them, developing messaging that is most attractive to customers, physicians, patients, and/or key opinion leaders, and/or other decisions. For example, based on the x-factor analysis, the analysis system 100 may automatically adjust the next month's inventory purchase, order a consulting session for a practice, post an electronic marketing flyer on a particular consumer's social network page, send a set of potential customers an email providing an offer of financing, send a link to clinical trial “game” to a provider which will boost the provider's score if completed successfully, and so forth.

It is recognized that other embodiments of FIG. 3 may be used. For example, the method of FIG. 3 could be repeatedly performed to generate recommended decisions or actions in real-time or on a periodic basis. In addition, information on a segment of companies, products, or services could be analyzed and/or companies, products, or services other than the top companies, products, or services could be analyzed.

Example Computing System

FIG. 4 illustrates an example configuration of an analysis system 100 for implementing aspects of the present disclosure. The analysis system 100 includes, for example, a personal computer that is IBM, Macintosh, or Linux/Unix compatible or a server or workstation. In one embodiment, the analysis system 100 comprises a server, desktop computer, and/or a laptop computer, for example. In one embodiment, the exemplary analysis system 100 includes one or more central processing unit (“CPU”) 105, which may each include a conventional or proprietary microprocessor. The analysis system 100 further includes one or more memory 130, such as random access memory (“RAM”) for temporary storage of information, one or more read only memory (“ROM”) for permanent storage of information, and one or more mass storage devices 120, such as a hard drive, diskette, solid state drive, or optical media storage device.

According to FIG. 4, information is provided to the analysis system 100 from one or more systems and/or internal or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, an object-oriented database, and/or a record-based database.

In the embodiment of FIG. 4, the analysis system 100 also includes data aggregation module 150, data analysis module 154 and action generator module 156 that may be stored in the mass storage device 120 as executable software codes that are executed by the CPU 105. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 4, the analysis system 100 is configured to execute the data aggregation module 150 to receive and process various data associated with participants, consumers, companies, products and/or services, as described above. In the illustrated embodiment, the analysis system 100 is further configured to execute data analysis module 154 in order to analyze the received data, identify market leaders, identify x-factors, determine ways in which a target company could improve or optimize a product, line of products, a procedure, the target's marketing strategy, and/or another aspect of the target's business, and/or other functionality described herein. The analysis system 100 may be further configured to execute the action generator module 156 in order to generate one or more reports or user interfaces regarding a target, which may include one or more recommended business decisions and may be used to make operating decisions, product decisions, marketing decisions and/or for other purposes described herein. One or more of the illustrated modules 150, 154 and/or 156 may, depending on the embodiment, implement any other functionality described elsewhere in this specification.

Typically, the modules of the analysis system 100 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of analysis system 100 may be combined into fewer components and modules or further separated into additional components and modules.

The analysis system 100 is generally controlled and coordinated by operating system software, such as Windows XP, Windows Vista, Windows 7, Windows Server, Unix, Linux, SunOS, Solaris, or other compatible operating systems. In Macintosh systems, the operating system may be any available operating system, such as MAC OS X. In other embodiments, the analysis system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary analysis system 100 may include one or more commonly available input/output (I/O) devices and interfaces 110, such as a keyboard, mouse, touchpad, and printer. In one embodiment, the I/O devices and interfaces 110 include one or more display devices, such as a monitor, that allows the visual presentation of data to a user. More particularly, a display device provides for the presentation of GUIs, application software data, and multimedia presentations, for example. The analysis system 100 may also include one or more multimedia devices 140, such as speakers, video cards, graphics accelerators, and microphones, for example.

In the embodiment of FIG. 4, the I/O devices and interfaces 110 provide a communication interface to various external devices. In the embodiment of FIG. 4, the analysis system 100 is electronically coupled to a network 160, which comprises one or more of a LAN, WAN, and/or the Internet, for example, via a wired, wireless, or combination of wired and wireless, communication link. The network 160 communicates with various computing devices and/or other electronic devices, such as those described above with reference to FIGS. 1 and 2, via wired or wireless communication links. Additionally, it should be noted that in some embodiments, the analysis system may be executed by one more virtual machines implemented in a hosted computing environment, which may also be referred to as a cloud computing environment. In some embodiments, one or more of the participant community platform 104, the credit and financing system 106, the business management system 112, the inventory tracking system 114, the customer community platform 116, the corporate user system 176, the participant systems 170 and/or the customer devices 172 may include components similar to those discussed above with reference to analysis system 100. In some embodiments, the analysis system may provide the functionality of one or more of the other systems illustrated in FIG. 1, such that one or more of the other illustrated systems of FIG. 1 are not needed.

### ADDITIONAL EMBODIMENTS

In general, the word “module,” as used herein, refers to logic embodied in hardware or firmware, or to a collection of software instructions, possibly having entry and exit points, written in a programming language, such as, for example, Java, Lua, C, C++ or C#. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the analysis system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by an analysis system, interactive community platform, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the disclosure. It will be appreciated, however, that no matter how detailed the foregoing appears in text, the systems and methods can be practiced in many ways. As is also stated above, it should be noted that the use of particular terminology when describing certain features or aspects of the various embodiments should not be taken to imply that the terminology is being re-defined herein to be restricted to including any specific characteristics of the features or aspects of the various embodiments with which that terminology is associated.

1. A system for automatically generating an electronic action recommendation based at least in part on various data, the system comprising:
a data store that stores information associated with a plurality of companies; and
a computing device in communication with the data store and that is configured to:
receive data associated with one or more of the companies from a plurality of data sources, wherein the received data comprises data related to at least one of sales, inventory, marketing, operations or product design;
automatically analyze the received data and data retrieved from the data store to determine one or more aspects of at least one company that correlate with one or more criteria to be optimized; and
automatically generate an electronic action recommendation to be taken by a company based at least in part on the one or more determined aspects.

2. The system of claim 1, wherein the electronic action recommendation relates to at least one of operations, product development, marketing or allocation of resources.

3. The system of claim 1, wherein the criteria to be optimized comprises at least one of sales, usage, customer satisfaction, cost, allocation of resources, revenue, profits, closing rates or gross margins.

4. The system of claim 1, wherein the computing device is further configured to generate a user interface for display that includes an indication of the electronic action recommendation.

5. A computer-implemented method for automatically generating an electronic action recommendation based at least in part on various data, the computer-implemented method comprising:
as implemented by one or more computing devices configured with specific executable instructions:
electronically receiving data associated with a plurality of companies from a plurality of data sources, wherein the received data comprises data related to at least one of sales, inventory, marketing, operations or product design;
automatically analyzing the received data to determine one or more aspects of at least one company that correlate with one or more criteria to be optimized; and
automatically generating an electronic action recommendation to be taken by a company based at least in part on the one or more determined aspects.

6. The computer-implemented method of claim 5, wherein the electronic action recommendation relates to at least one of operations, product development, marketing or allocation of resources.

7. The computer-implemented method of claim 5, wherein the criteria to be optimized comprises at least one of sales, usage, customer satisfaction, cost, allocation of resources, revenue, profits, closing rates or gross margins.

8. The computer-implemented method of claim 5, further comprising generating a user interface for display that includes an indication of the electronic action recommendation.

9. A non-transitory computer-readable medium storing computer-executable instructions that, when executed by a computer system, configure the computer system to perform operations comprising:
electronically receiving data associated with a plurality of companies from a plurality of data sources, wherein the received data comprises data related to at least one of sales, inventory, marketing, operations or product design;
automatically analyzing the received data to determine one or more aspects of at least one company that correlate with one or more criteria to be optimized; and
automatically generating an electronic action recommendation to be taken by a company based at least in part on the one or more determined aspects.

10. The non-transitory computer-readable medium of claim 9, wherein the electronic action recommendation relates to at least one of: operations, product development, marketing or allocation of resources.

11. The non-transitory computer-readable medium of claim 9, wherein the criteria to be optimized comprises at least one of: sales, usage, customer satisfaction, cost, allocation of resources, revenue, profits, closing rates or gross margins.

12. The non-transitory computer-readable medium of claim 9, wherein the computer-executable instructions further configure the computer system to generate a user interface for display that includes an indication of the electronic action recommendation.

13. The non-transitory computer-readable medium of claim 9, wherein automatically analyzing the received data comprises implementing an artificial neural network that identifies correlations between data of one or more data types within the received data and the one or more criteria to be optimized.

14. The non-transitory computer-readable medium of claim 9, wherein generating the electronic action recommendation to be taken by the company comprises determining whether the company is over-performing, underperforming or optimally positioned with respect to the one or more determined aspects.

15. The system of claim 1, wherein automatically analyzing the received data comprises implementing an artificial neural network that identifies correlations between data of one or more data types within the received data and the one or more criteria to be optimized.

16. The system of claim 1, wherein the computing device is further configured to, prior to analyzing the received data, segment the received data based at least in part on consumer demographic information included in the received data.

17. The system of claim 1, wherein generating the electronic action recommendation to be taken by the company comprises determining whether the company is over-performing, underperforming or optimally positioned with respect to the one or more determined aspects.

18. The system of claim 1, wherein the company for which the electronic action recommendation is generated is different than the at least one company for which the one or more aspects are determined.

19. The computer-implemented method of claim 5, wherein automatically analyzing the received data comprises implementing an artificial neural network that identifies correlations between data of one or more data types within the received data and the one or more criteria to be optimized.

20. The computer-implemented method of claim 5, wherein generating the electronic action recommendation to be taken by the company comprises determining whether the company is over-performing, underperforming or optimally positioned with respect to the one or more determined aspects.
